(19) United States
(12) Patent Application Publication
(10) Pub. No.: US 2009/0180429 A1
(43) Pub. Date: Jul. 16, 2009

(54) Broadband Unlicensed Spread Spectrum

(75) Inventors: Gilman R. Stevens, Fairview, TX (US); Thomas Schwengler, Lakewood, CO (US)

Correspondence Address: Qwest Communications International Inc., 1801 California Street, # 900, Denver, CO, 80202, US

(73) Assignee: Qwest Communications International Inc., Denver, CO (US)

(21) Appl. No.: 11/972,455

(22) Filed: Jan. 10, 2008

(51) Int. Cl. H04Q 7/00

(52) U.S. Cl. 370/329

(57) ABSTRACT

A wireless device with multiple antennas is provided according to one embodiment of the invention. The wireless device may be configured to utilize the antennas to communicate with one or more wireless terminals in various ways. According to various embodiments of the invention, these scenarios may include, for example, switching between antennas or software controlled antenna modulation and therefore potentially switching between networks based on application-specific needs; switching antennas based on range limitations; switching between antennas based on aggregation on one network; utilizing multiple antennas to handle high data throughput; switching between antennas based on security needs; and/or switching between antennas based on cost. Various other embodiments of the invention may provide a wireless device that may switch between antennas and therefore networks based on any combination of these scenarios. Methods for switching between wireless networks based on various parameters are also disclosed.

### FIELD OF THE INVENTION

This disclosure relates in general to wireless communication and, but not by way of limitation, to wireless communication using one or more unlicensed frequency bands among other things.

### BACKGROUND

The availability of spectrum for unlicensed operations has spawned a significant market for unlicensed devices. These devices range from simple consumer devices, such as cordless telephones, remote control toys, personal computers, garage door openers and baby monitors to sophisticated business and commercial applications, such as security systems, inventory control systems, manufacturing controls, and business computing networks.

The growing popularity of computer networking has stimulated a heightened interest in unlicensed technology and one of the fastest growing applications of unlicensed devices is for wireless local area networks (WLANS). Because most businesses and many homes now have multiple computers, users often find it desirable to install local area networks to share resources such as printers, scanners and broadband or dial-up Internet connections. Developing a local area network using wireless unlicensed devices can be cost-attractive when compared with the costs of wired networks and offers the added benefit of instant portability.

The same spread spectrum technology that has been used for cordless telephones and other unlicensed devices has been adapted to meet the surging demand for computer and data networking. Among the more popular of these unlicensed devices are wireless data devices that operate in the 2.4 GHz band in accordance with the 802.11b or “WiFi” standards and protocols developed by the LAN/MAN Standards Committee (LMSC) of the Institute of Electrical and Electronic Engineers. Unlicensed devices operating under the 802.11b/WiFi protocols can be used to link computers or other digital devices at distances up to about 150 feet and with data rates of up to 11 Mbps. Other IEEE protocols have recently been developed, such as 802.11a which operates at 5 GHz and 802.11g which is an extension of 802.11b, that provide even higher data rates. Another unlicensed wireless networking standard is HomeRF developed by the HomeRF Working Group. This technology provides data capabilities similar to WiFi but also includes voice capability.

Unlicensed consumer devices are also being developed to provide very short-range (on the order of 10 meters) wireless “personal area” networks (WPANs). “Bluetooth,” which uses 2.4 GHz spread spectrum frequency hopping technology, is the dominant WPAN technology at this time. Bluetooth devices are beginning to be included in many devices such as mobile radiotelephones, laptop computers, printers and personal digital assistants (PDAs) and some experts believe that it could become a standard feature in many consumer electronic devices. Finally, other unlicensed technologies, such as power line carrier (PLC) systems that use the electric power lines to transmit data and ultra wideband (UWB) devices, are being developed and hold great promise for providing consumers with new data and computer networking capabilities.

While the Federal Communication Commission provides regulatory authority over unlicensed spectrum, often the rules and etiquette established by industry groups shape use within the unlicensed spectrum. These spectrum protocols or etiquettes are the rules or procedures that must be used by unlicensed devices to gain access to the spectrum. For example, a simple spectrum etiquette might require that a device “listen” for a certain period of time to ensure that the spectrum is unoccupied before it begins transmitting and that transmissions be limited to a fixed amount of time so that no one device can occupy the spectrum all of the time. There are currently mandatory protocols in Part 15 of the rules for Unlicensed PCS systems. In addition, industry groups such as IEEE have developed and are developing voluntary protocols for certain types of unlicensed devices. For example, IEEE Task Group 802.15.2 is developing recommended practices for the collaborative use of WiFi and Bluetooth devices in the 2.4 GHz range to ensure that these devices can co-exist and do not interfere with each other.

Moreover, other issues related to the unlicensed spectrum include aggregation of noise across the spectrum. Such noise aggregation may limit their range or raise the cost of infrastructure to serve a given communication market.

### BRIEF SUMMARY

A wireless device with multiple antennas is provided according to one embodiment of the invention. The wireless device may be configured to utilize the antennas to communicate with one or more wireless terminals in various ways. According to various embodiments of the invention, these scenarios may include, for example, switching between antennas and therefore potentially switching between networks based on application-specific needs; switching antennas based on range limitations; switching between antennas based on aggregation on one network; utilizing multiple antennas to handle high data throughput; switching between antennas based on security needs; and/or switching between antennas based on cost. Various other embodiments of the invention may provide a wireless device that may switch between antennas and therefore networks based on any combination of these scenarios. Methods for switching between wireless networks based on various parameters are also disclosed. The examples described below are provided to show application of various embodiments of the disclosure and are not used to limit the scope and/or claims of the disclosure.

As a first example, a user may use an instant message (IM) application on a wireless device that requires very little bandwidth using a first wireless network. After using the IM application the user may then surf the web using a web browser application that may require significantly more bandwidth. Accordingly, the wireless device may search to a second wireless network using a second antenna that may provide the required bandwidth for surfing the web.

As another example, a user may approach the range limits of a first wireless network. The wireless device and/or wireless terminal may measure the signal strength of the signals between the two devices. As the wireless device approaches or passes the range limit, the wireless device may determine if there are other available wireless networks available that the wireless device is within range. The wireless device may then switch to another wireless network that is within range. The wireless device may take bandwidth, latency, cost and/or security into account when determining which of the available networks to switch if any.

As another example, a user may use a wireless device connected with a first wireless network using a first antenna. The wireless network may or may not require a fee to gain access to the first wireless network. The wireless network may slow because of network aggregation and/or congestion. The mobile device may detect this aggregation and/or congestion by measuring a decrease in bandwidth and/or an increase in latency. The mobile device may then search for and find a second wireless network with less aggregation and/or congestion. The wireless device may then switch to the second wireless network using a second antenna.

As yet another example, a wireless device may utilize multiple wireless networks via multiple antennas to provide increased data throughput. For instance, the user may require data throughput greater than an individual wireless network may provide. Accordingly, the wireless device may communicate with a network over multiple wireless networks thus increasing the data throughput. Data may be communicated in data packets in various configurations. Data packets may be communicated over an individual network based on the percentage of bandwidth the individual network may provide. Accordingly, the data may be spread across multiple frequency bands. These frequency bands may be unlicensed frequency bands. Moreover, each frequency band may require a different modulation, multiplexing, and/or coding scheme.

As another example, a wireless device may switch between antennas based on security needs. A user may use a wireless device to access a secure webpage such as a bank's webpage. In doing so the user may require a heightened level of security. As such, if the wireless device used by the user is not connected to the Internet over a wireless network with a high enough level of security, the wireless device may search for other wireless networks with higher levels of security. If the wireless device finds a more secure wireless network, the wireless device may connect to that network in order to provide the necessary level of security to the user. In doing so, for example, the wireless device may sacrifice bandwidth, speed, latency, etc. in order to provide the required security.

As a final example, the wireless device may switch between antennas based on cost. A user may gain access to a first wireless network using a first antenna. Access to the first wireless network may require a fee. While accessing the first wireless network, the wireless device may search for other available networks in the area. If a second, less expensive wireless network is available, the wireless device may switch to the second wireless network. The second wireless network may be accessed using a second antenna. In some cases, the user may be prompted whether they wish to switch to the second wireless network and may be made aware of the speed, bandwidth and/or latency differences between the two networks.

A method for allocating wireless communication over one or more frequency bands of the unlicensed frequency spectrum is disclosed according to one embodiment of the invention. The method may include detecting the signal strength of each of the frequency bands and determining whether the signal strength of each of the frequency bands is greater than a threshold value. The method may also include allocating data packets to the available frequency bands with a signal strength greater than a threshold value, wherein the data packets are assigned in proportion to the available bandwidth at each frequency band, and transmitting data packets within the allocated frequency bands. The frequency bands may include frequency bands in the unlicensed frequency spectrum. The frequency bands may include frequency bands centered around about 450 MHz, 850 MHz, 868 MHz, 900 MHz, 915 MHz, 1.7 GHz, 1.8 GHz, 1.9 GHz, 2.0 GHz 2.1 GHz, 2.3 GHz, 2.4 MHz, 2.5 GHz, 2.7 GHz, 3.5 GHz, 3.7 GHz, 5.3 GHz, 5.4 GHz, 5,7 GHz and 5.8 GHz. Other frequency bands may also be used as shown in the tables below.

A method for wireless communication between a wireless device and wireless terminals is disclosed according to one embodiment of the invention. The wireless device may include a plurality of antennas configured to transmit data within a plurality of frequency bands. The method may include transmitting data over a first wireless communication signal using a first frequency band to a recipient through a first communication wireless terminal and monitoring the signal strength of the first signal. The method may also include determining whether the signal strength of the first signal is below a threshold value. The method may determine the availability of frequency bands other than the first frequency band and transmit data over an available frequency band other than the first frequency band when the signal strength of the first signal is below the threshold value. The wireless device may be a mobile phone and the data is voice data. The method may also include measuring the bandwidth of the available frequency bands other than the first frequency band. The frequency bands may include frequency bands centered around about 450 MHz, 850 MHz, 868 MHz, 900 MHz, 915 MHz, 1.7 GHz, 1.8 GHz, 1.9 GHz, 2.0 GHz 2.1 GHz, 2.3 GHz, 2.4 MHz, 2.5 GHz, 2.7 GHz, 3.5 GHz, 3.7 GHz and 5.8 GHz. Other frequency bands may also be used as shown in the tables below.

A wireless device is also disclosed according to one embodiment of the invention. The wireless device may include a plurality of antennas and a controller. Each antenna may be configured to communicate with one or more wireless terminals using a different frequency band. The controller may be coupled with the plurality of antennas. The controller may be configured to determine the available bandwidth of each frequency band and configured to allocate the transmission of data packets over each of the frequency bands with available bandwidth. The wireless device may be configured to access portions of the unlicensed frequency spectrum.

A method for communicating wirelessly between a wireless device and a wireless terminal is provided according to another embodiment of the invention. The method may include communicating data between the wireless device and the wireless terminal using a first frequency band, wherein the data comprises a first data type. The method also includes detecting a change in the data from a first data type to a second data type. The method further includes communicating data between the wireless device and the wireless terminal using a second frequency band, wherein the second frequency band provides network efficiencies. The method may further include communicating the data with the second data type between the wireless device and the wireless terminal using the second frequency band. The second frequency is at least as efficient as communicating data in the second type using the first frequency band. The first data type and the second data type may include voice-over IP; TCP/IP, UDP, multimedia data, instant messaging, text messaging, internet protocol packet, voice-over instant messaging, SCTP, and SPX.

A method for wireless communication between a wireless device and communication wireless terminals is provided according to one embodiment of the invention. The wireless device may include a plurality of antennas configured to transmit data using a plurality of wireless networks. The method may include transmitting data with a first wireless network and detecting a change in an application-specific network characteristic at the wireless device. The method may then transmit data with a second wireless network, wherein the second wireless network provides network characteristics that satisfy the application-specific network characteristic. The application-specific network characteristic may include bandwidth, latency, security, and/or cost. Each of the wireless networks may include a frequency band within which data is communicated. The method may further include transmitting data with a third wireless network, wherein the third wireless network provides network characteristics that satisfy the application-specific network characteristic in conjunction with the second wireless network.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 shows an exemplary wireless device within the communication range of five wireless terminals each of which are operating within a different frequency band according to one embodiment of the invention.

FIG. 2 shows a flowchart depicting a method for monitoring application-specific bandwidth requirements for an application according to one embodiment of the invention.

FIG. 3 shows a flowchart depicting a method for allocating data across frequency bands in response to wireless device approaching range limitations according to one embodiment of the invention.

FIG. 4 shows a flowchart depicting a method for finding a frequency band in the event the throughput of the current band decreases according to another embodiment of the invention.

FIG. 5 shows an exemplary wireless device within the communication range of four wireless terminals, three of which are operating within a different frequency band and a fourth communicating with three frequency bands according to one embodiment of the invention.

FIGS. 6A, 6B, 6C and 6D show different ways a series of data packets may be broken up and transmitted over different frequencies according to one embodiment of the invention.

FIG. 7 shows a flowchart depicting a method for adding and dropping bandwidths depending on the signal strength of the bands according to one embodiment of the invention.

FIG. 8 shows a flowchart depicting a method for allocating bandwidth across available frequency bands when the default bandwidth falls below requirements according to one embodiment of the invention.

FIG. 9 shows a flowchart depicting a method for allocating data across frequency bands based on the signal-to-noise ratio of the available frequency bands according to one embodiment of the invention.

FIG. 10 shows a flowchart depicting a method for allocating data on bandwidths that have a signal strength greater than a threshold bandwidth according to one embodiment of the invention.

FIG. 11 shows a flowchart depicting a method for determining whether a user and/or device should allocate data across available frequency bands according to one embodiment of the invention.

FIG. 12 shows a flowchart depicting a method for monitoring changes in the security requirements and allocating the data across bandwidths that meet the security requirements according to one embodiment of the invention.

FIG. 13 shows a flowchart depicting a method for determine whether bandwidths meet application-specific needs according to one embodiment of the invention.

FIG. 14 shows a block diagram of a multiple antenna wireless device according to one embodiment of the invention.

FIG. 15 shows a block diagram showing software modules that implement various embodiments of the present invention.

FIG. 16 shows a flowchart of a method for determining user usage profiles and applying user usage profiles in choosing wireless networks according to one embodiment of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

As used throughout this disclosure, the term “wireless network” refers to any type of communication network whose interconnections between nodes are implemented without the use of wires. A wireless network uses electromagnetic waves as a carrier wave. In some cases wireless networks operate using any of number of wireless protocols and/or standards. For instance, protocols and/or standards may be implemented by a consumer group such as the IEEE and/or a government agency such as the FCC. A wireless network may also operate at given frequency band. Wireless protocols and/or standards often dictate the means for sharing of a frequency band, the power of transmitters using the band which corresponds to the range and the data bandwidth of the frequency band.

The term “frequency band” refers to a portion of the electromagnetic spectrum that is used as a carrier wave for a data signal. Typically frequency bands are referred to based on their center frequency and are bounded by a lower and upper bounds. Many wireless frequency bands in particular are portions of the unlicensed spectrum. These frequency bands may include, for example, PCS, AWS, cellular, GSM, WiMax, marine frequencies, aviation frequencies and deep space frequency bands. The following table lists, without limitation, exemplary frequency bands and. This listing may not be complete. Various other frequency bands may be used by the embodiments of the invention.

| System | Frequency Bands (MHz) |
|---|---|
| SMR iDEN | 806-824 and 851-869 |
| AMPS, GSM, IS-95, IS-136 | 824-849, 869-894, 896-901, 935-940 |
| GSM, IS-95, IS-136 | 1850-1910 and 1930-1990 |
| 3G | 700 range, 1432-1435, 1710-1755, |
| | 2110-2170, 2500-2690 |
| WiMAX | 2000-11,000, 10,000-66,000 |
| | 2300, 2500, 3500 |
| “Auction 73” (auctioned by | 700 |
| FCC Jan. 24, 2008) | |
| Maritime | 2.182, 41.4, 21.303, 14.303, 14.121, |
| | 7.241, 16.36-17.41, 7.086, 14.313, |
| | 14.300, 156-174, 1500-1535, etc. |
| Inter-satellite | 22.55-23.55 |
| Amateur Satellite | 7.0-7.1, 21.0-21.4, 28.0-29.7, 1045-1050, |
| | 47,000-47,200, 75,500-81,000, |
| | 142,000-149,000 |

As used throughout this disclosure the term “bandwidth” refers to data rate. That is, bandwidth may refer to the number of bits or bytes that may be transmitted in a period of time. For example, a wireless network with a bandwidth of 100 Kbit/s transmits 100,000 bits per second. The bandwidth of a wireless network may depend on a number of factors. The term “throughput” may be used throughout this disclosure as a synonym for bandwidth.

As used throughout this disclosure the term “wireless device” refers to a device that communicates wirelessly with a network. The wireless device may be mobile or stationary. For example a wireless device may be a personal data assistant, a mobile phone, a telephone, a voice-over IP telephone, a computer, a laptop, a server, a digital music device, smart-hone, etc.

As used throughout this disclosure the term “wireless protocol” refers to a standard for communication over a wireless network. Wireless protocols may be designated by a professional organization (such as IEEE) or a government agency (such as the FCC). These protocols may dictate how frequency bands are shared. A wireless protocol may be part of the data link layer. A wireless protocol may dictate the frequency band, the power, the range, and/or the modulation scheme used for devices that communicate within a specific frequency band. Wireless protocols may include, for example, wireless application protocol, wireless internet protocol, wireless routing protocol, Bluetooth, WiFi 802.11a/b/g/n, EDDO, COMA, wireless USB, wireless LAN, Imax, etc.

The following table lists exemplary wireless protocols, their frequency bands, downlink and uplink rates, wireless operating range and whether the protocol operates within a licensed or unlicensed portion of the spectrum. The table is in no way meant to be definitive or complete. Rather, the table is provided as an example of various wireless protocols. While these protocols are shown, those skilled in the art will recognize that any other protocol, wireless network, frequency band, etc may be used by the embodiments of the invention, without limitation.

| | | Max | Max | | | |
|---|---|---|---|---|---|---|
| | | Downlink | Uplink | Range | | Spectrum |
| Standard | Frequency | (Mbps) | (Mbps) | (approx) | | Type |
| UMTS-TDD | 2 GHz | 16 | 16 | 18 | mi | Unlicensed |
| UMTS W- | 850 MHz, 1.9, 1.9/2.1, & | 14.4 | 5.760 | 18 | mi | Licensed |
| CDMA | 1.7/2.1 GHz | | | | | |
| UMTS-TDD | 450, 850 MHz, 1.9, 2, 2.5, | 16 | 16 | | | Licensed |
| | & 3.5 GHz | | | | | |
| CDMA2000 | 450, 700, 800 850, & 900 MHz | 0.307 | 0.153 | 18 | mi | Licensed |
| RTT 1x | 1.7, 1.8, 1.9, & 2.1 GHz | | | | | |
| CDMA EV-DO | 450, 700, 800 850, & 900 MHz | 0.307 | 0.153 | 18 | mi | Licensed |
| rev. 0 | 1.7, 1.8, 1.9, & 2.1 GHz | | | | | |
| CDMA EV-DO | 450, 700, 800 850, & 900 MHz | 2.458 | 0.153 | 18 | mi | Licensed |
| rev. A | 1.7, 1.8, 1.9, & 2.1 GHz | | | | | |
| CDMA EV-DO | 450, 700, 800 850, & 900 MHz | 3.100 | 1.800 | 18 | mi | Licensed |
| rev. B | 1.7, 1.8, 1.9, & 2.1 GHz | | | | | |
| GSM GRPS | 450, 700, 800 850, & 900 MHz | 0.08 | 0.04 | 16 | mi | Licensed |
| | 1.7, 1.8, 1.9, & 2.1 GHz | | | | | |
| GSM EDGE | 850, 900 MHz 1.8, 1.9 GHz | 0.474 | 0.474 | 16 | mi | Licensed |
| 802.16e | 2.3, 2.5, 3.5, 3.7 & 5.8 GHz | 70 | 70 | 4 | mi | Licensed |
| (WiMax) | | | | | | |
| 802.11a (WiFi) | 5.25, 5.6 & 5.8 GHz | 54 | 54 | 35 | meters | Unlicensed |
| 802.11b (WiFi) | 2.4 GHz | 11 | 11 | 38 | meters | Unlicensed |
| 802.11g (WiFi) | 2.4 GHz | 54 | 54 | 38 | meters | Unlicensed |
| 802.11n (WiFi) | 2.4 GHz | 200 | 200 | 70 | meters | Unlicensed |
| Bluetooth | 2.4 GHz | 3 | 3 | 1-100 | meters | Unlicensed |
| Wibree | 2.4 GHz | 1 | 1 | 10 | meters | Unlicensed |
| ZigBee | 868, 915 MHz, 2.4 GHz | 0.25 | 0.25 | 10-75 | meters | Unlicensed |
| Wireless USB, | 3.1 to 10.6 GHz | 480 | 480 | 3 | meters | Unlicensed |
| UWB | | 110 | 110 | 10 | meters | |
| EnOcean | 868.3 MHz | 0.120 | 0.120 | 300 | | Unlicensed |
| WiBro | 8.75 MHz, 2.3-2.4 GHz | 50 | 50 | 1-5 | Km | Unlicensed |
| Hiperman | 2-11 GHz | 56.9 | 66.9 | | | Unlicensed |
| | 3.5 GHz | | | | | |
| iBurst (HC- | 625 KHz, 1.8 GHz | 50 | 50 | | | Unlicensed |
| SDMA) | | | | | | |
| LTE UMTS | | >100 | >50 | 5-100 | Km | |
| (3GPP LTE) | | | | | | |
| WiMedia | 2.4 GHz | 53-480 | 53-480 | | | Unlicensed |

The term “wireless protocol” may further extend to refer to a “wireless communication standard”. Various wireless communication standards are currently in use. For example, these standards may include the 0G, 0.5G, 1G, 2G, 2.5G, 2.75G, 3G, 3.5G, 3.75G, 4G and/or any further generation of theses standards. For example, the 0G standard may include PTT, MTS, IMTS, and/or AMTS. For example, the 0.5G standard may include Autotel/PALM, ARP, IG, NMT, AMPS, Hicap, CDPD, Mobitex, and/or DataTac. For example, the 2G standard may include GSM, iDEN, D-AMPS, cdmaOne, PDC, CSD, and/or PHS. For example, the 2.5G standard may include GPRS, HSCSD, and WiDEN. For example, the 2.75G standard may include CDMA2000 1xRTT, and/or EDGE. For example, the 3G standard may include W-CDMA, UMTS, FOMA, TD-CDMA/UMTS-TDD, CDMA2000 1xEV, TD-SCDMA, UMA, and/pr Mobile WiMAX. For example, the 3.5G standard may include HSDPA. For example, the 3.75G standard may include HSUPA and/or HSOPA/LTE. For example, the 4G standard may include UMB.

As used throughout this disclosure the term “wireless terminal” is a device that communicates wirelessly with a wireless device. A wireless terminal may be the link between a wireless device and a network. For example, a wireless terminal may include, without limitation, a wireless router, wireless switch, a cellular antenna, a cell site, a mobile phone mast, a base station, a cell site, a base transceiver station, etc.

As used throughout this disclosure the term “network efficiency” refers generally to use of a wireless network that avoids latency and yet does not use more bandwidth than is needed. For example, an efficient use of a wireless network has no latency and yet transmits data at a rate near the bandwidth limit of the wireless network. As another example, use of a wireless network with either latency or transmitting data at a lower data rate while tying up a higher bandwidth results in a less efficient network.

As used throughout this disclosure the term “range” is the maximum range possible to receive data at 25% of the typical rate.

According to one or more embodiments of the invention, a wireless device with multiple antennas is provided. Each antenna may be configured to communicate with a wireless terminal using a different frequency band. For example, a wireless device may be configured with three antennas. The first antenna can communicate with a router using WiFi at 5.25 MHz, the second antenna can communicate with an EDGE router at 2.75 GHz, and the third antenna can communicate with a CDMA2000 router at 900 MHz.

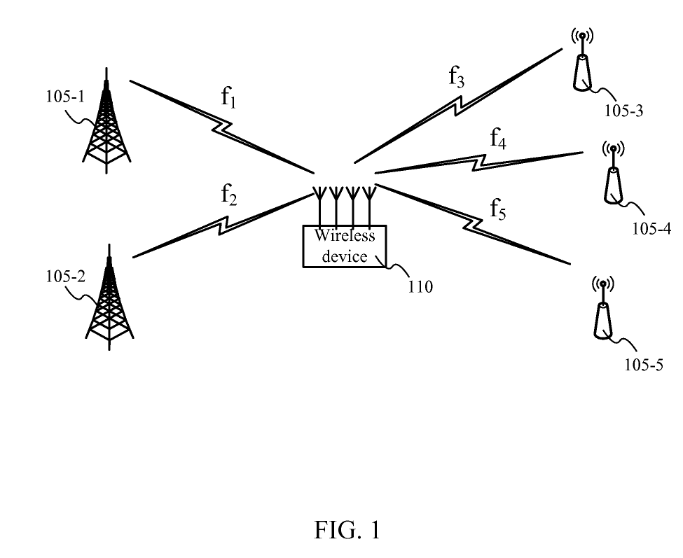

FIG. 1 shows an exemplary wireless device 110 within the communication range of five wireless terminals 105, each of which are operating at a different frequency band according to one embodiment of the invention. As shown, the wireless device is within communication range of at least these five wireless terminals. If the wireless device 110 includes antennas that operate at the frequency bands of each of the wireless terminals, then the wireless device may communicate with the wireless terminals 105. As shown in the figure, the wireless device 110 includes four antennas. Accordingly, the wireless device may only communicate with four wireless terminals 105 if the antennas operate at the proper frequency band. Of course, some of the wireless terminals 105, while not shown, may operate at different frequency bands.

A wireless device 110 with multiple antennas may be configured to utilize the antennas to communicate with one or more wireless terminals in various ways. According to various embodiments of the invention, these scenarios may include, for example, 1) switching between antennas and therefore potentially switching between networks based on application-specific needs; 2) switching antennas based on range limitations; 3) switching between antennas based on aggregation on one network; 4) utilizing multiple antennas to handle high data throughput; 5) switching between antennas based on security needs; and/or 6) switching between antennas based on cost. Various other embodiments of the invention may provide a wireless device 110 that may switch between antennas and therefore networks based on any combination of these scenarios.

Application-Specific Bandwidth Use

The wireless device may switch between antennas, and therefore potentially switch between wireless networks, based on application-specific bandwidth use according to one embodiment of the invention. For example, a user may be using an instant message (IM) application on the wireless device to communicate with a friend. An IM application may use only a very small portion of the available bandwidth at a first frequency band. Accordingly, a low bandwidth connection, such as a WiFi network, may provide the requisite level of service for the IM application executing on the wireless device. Moreover, some protocols associated with different frequency bands may provide efficiencies specific for IM applications. Thus, the wireless device may communicate IMs using a first antenna over the first network operating with a first frequency band.

For example, the user may stop using the using the IM application and then proceed to view a video on the Internet. The video may be streamed using UDP packets, for example. The video stream requires increased bandwidth over the bandwidth required for the IM application. Accordingly, the wireless device may switch to a second wireless terminal over a second frequency band. The second wireless terminal and the first wireless terminal may be part of the same wireless terminal and provide multiple access to the network. The second frequency band may have more bandwidth to provide the increase in data packets from the IM application to the video application. For example, the second wireless network may be a WiMAX network. The second wireless terminal may also require a second protocol that provides for efficiencies streaming the video.

For example, the user may then stop streaming video and turn to reading and responding to email messages. As such, the wireless device may react to the changed bandwidth needs from streaming video to email reading and sending. Accordingly, if a third wireless network is available that provides efficiencies for email traffic over the first and second wireless networks and if the third wireless network has a significantly strong signal, the wireless device may switch to the third wireless network while the user is emailing. This third wireless network may be either the first or second wireless network. The wireless device may switch to this third wireless network based on heuristic measurements of past use. These heuristic measures may depend on specific users. A wireless device that switches between protocols and/or wireless networks, according to this embodiment of the invention, provides efficiencies in the network and may increase the total bandwidth available for all users.

As another example, a family may have access to a wireless router that provides WiFi and WiMAX network connectivity. Accordingly, if the kids require small bandwidth for IM applications or chatting, the kids may gain access to the Internet using the WiFi network. A parent, on the other hand, may use a virtual private network application to connect to a secure network and require higher bandwidth for work applications. Accordingly, the parent may access the network over the WiMAX network. As the parent and/or children's use changes, the wireless devices in use may switch between networks to provide the proper efficiencies.

As another example, a user may access a network for small bandwidth applications using an EDGE network. The wireless device may switch to a WiMAX network or a WiFi network for higher bandwidth needs.

The wireless device may change to the second frequency band based not only on bandwidth, but may also change to the second frequency based on network efficiency. For example, an IM application transmits and receives small amounts of data. However, some protocols and/or wireless networks communicate IM data using a large amount of bandwidth that may tie up network resources. Accordingly, if the user is surfing the web using a first wireless network and then begins to use an IM application, while the first wireless network should provide the requisite bandwidth for the IM application, it may do so inefficiently and tie up network resources. Therefore, a change to a second more efficient network for an IM application may be more efficient.

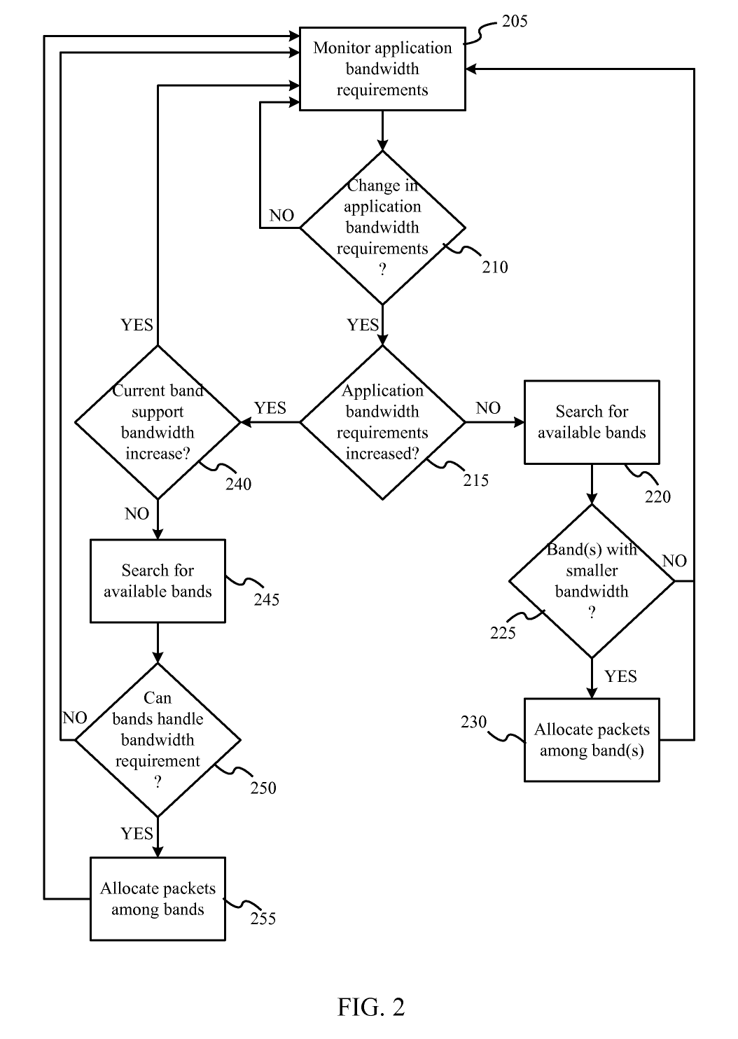

FIG. 2 shows a flowchart depicting a method for monitoring application-specific bandwidth requirements according to one embodiment of the invention. This flowchart may occur within a software or firmware routine and may execute from a controller within a wireless device. At block 205 the mobile device monitors the bandwidth requirements for the application currently in use. At block 210 the wireless device determines whether the application bandwidth needs have changed. If no change has occurred, then the wireless device continues to monitor the bandwidth use at block 205; otherwise the method determines if the bandwidth use has increased or decreased at block 215. Of course, the bandwidth needs may vary within a range without necessitating a change in bandwidth.

If the bandwidth requirement or use has decreased, the wireless device searches for available frequency bands at block 220. A separate routine, system, method, etc. may continuously search for available bandwidths and provide the results in a lookup table or other data structure. In such a case, the method may look at the data corresponding to available networks at block 220. Various other schemes may be employed to determine the available frequency bands. If the search returns a frequency band that provides a smaller bandwidth as determined at block 225, the data, such as packets, are allocated at block 330 among the smaller bandwidth; otherwise the method returns to block 205. Thus, if the application bandwidth requirements have decreased, the method searches for a frequency band that provides a more efficient communication scheme. Accordingly, bandwidth resources are not tied up with an application that requires low bandwidth. Thus, more efficient network use is utilized by the wireless device.

Returning back to block 215, if the application bandwidth requirement has increased, the system determines if the current band can support the bandwidth increase at block 240. If so, the mobile device continues to use the current frequency band and returns to block 205. Otherwise, the system again searches for available frequency bands at block 245. This search may be similar to the search performed in block 220. The mobile device then determines whether any of the available frequency bands can handle the increased bandwidth at block 250. If so, the data is transmitted on a new frequency band at block 255. In either case, the mobile device continues to monitor the bandwidth use of the application at block 205. Transmitting data on an available frequency band may occur over more than one frequency band.

Various other application-specific changes may initiate changes in the frequency band under which the wireless device connects with a network. For example, general web browsing, emailing, downloading files, playing network games, making a VOIP phone call, text messaging, instant messaging, streaming audio or video and/or using a virtual private network may initiate changes in network efficiency or necessitate an increase in bandwidth.

Range Limitations

The wireless device may switch between antennas and therefore wireless networks based on the range limitation of the wireless network in use according to one embodiment of the invention. Wireless networks have range limitations. For example, WiFi at 5.25 GHz using the 802.11a standard has a range of approximately 35 meters to 120 meters. As another example, CDMA EVDO has a range of about 18 miles. These range limitations may be dictated by power requirements of the wireless protocol.

According to this embodiment of the invention, the wireless device transmits and receives data on a first wireless network. During operation, the wireless device may monitor the signal strength of the first wireless network. Signal strength is an indicator of whether the wireless device is within the range of the wireless terminal or if the wireless device is approaching the range limit. Accordingly, if the wireless device detects that the signal strength has decreased below a threshold, the wireless device may monitor the available networks. If the wireless device detects that the signal strength at a second wireless network is greater than the first wireless network, then the wireless device may switch to the second wireless network. In another embodiment, the signal strength of the second network may be compared with a second threshold value. If the first signal strength is below the first threshold value and the second signal strength is greater than the second threshold value, then a change from the first to the second wireless network may occur. The wireless device may monitor the signal strength of the first wireless network. If the signal strength of the first wireless network is above the threshold value, then the wireless device may switch back to the first wireless network.

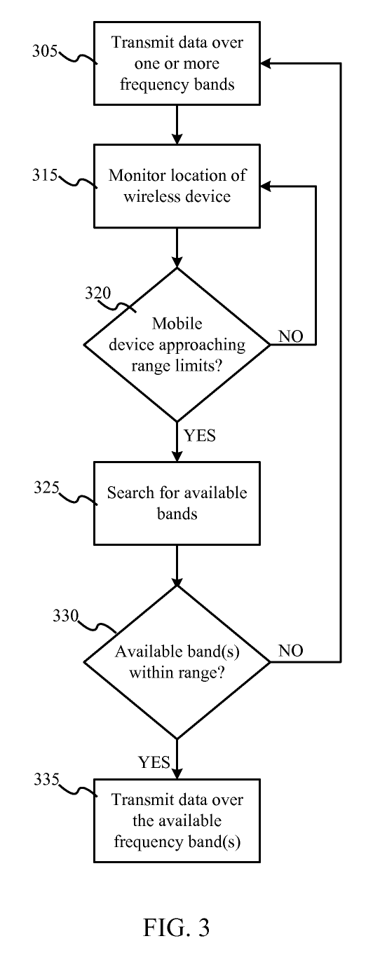

FIG. 3 shows a flowchart depicting a method for allocating data across frequency bands in response to wireless device approaching range limitations according to one embodiment of the invention. Data is transmitted between a wireless device and a wireless terminal over one or more frequency bands at block 305. The location of the wireless device is monitored at block 315. The relative distance between the wireless device and the wireless terminal may be determined. As the wireless device moves further and further from the wireless terminal or moves into a location that has more obstructions between the wireless device and the wireless terminal, the signal strength decreases and the relative distance between the wireless device and the wireless terminal increases. Accordingly, the wireless device may determine whether the wireless device is within the range limits of the frequency band at block 320 by monitoring the distance between the two. If it is within the range limits, then the wireless device continues to monitor the location of the wireless device at block 315 and continues to communicate with the wireless terminal.

If the device is approaching the range limits as found in block 320, then the wireless device may search for available bands at block 325. This search may be similar to the search performed in block 220 of FIG. 2. At block 330, the wireless device may then determine whether the available bands are within the range specified by the protocols and/or standards that are operative using the frequency band. If no bands are available and within range, the method returns to block 305. If a frequency band or bands is available and within range, then the wireless device may transmit data over the frequency band or bands.

Switching Based On Network Aggregation

According to another embodiment of the invention, switching between antennas may be based on network aggregation and/or congestion. Network congestion occurs when a wireless network carries so much data that its quality of service deteriorates. Typical effects, for example, may include queuing delay, packet loss or the blocking of new connections. One consequence of these latter two is that incremental increases in offered load lead either only to small increases in network throughput, or to an actual reduction in network throughput. Often exponential back-off is employed to avoid network congestion. Any type of back-off by a wireless device leads to a decrease in throughput and or bandwidth. Accordingly, the wireless device may monitor the throughput of the data transmitted over a first wireless network. If the wireless device determines that throughput has dropped below a threshold level, the wireless device may search for other available wireless networks. The wireless device may then select an available second wireless network based on the throughput of the second wireless network. In such an embodiment, the multiple antennas on a wireless device potentially provide more than one option for communication over a wireless network and permit a wireless device to find a wireless network that provides the necessary throughput for the needs of the user and/or applications.

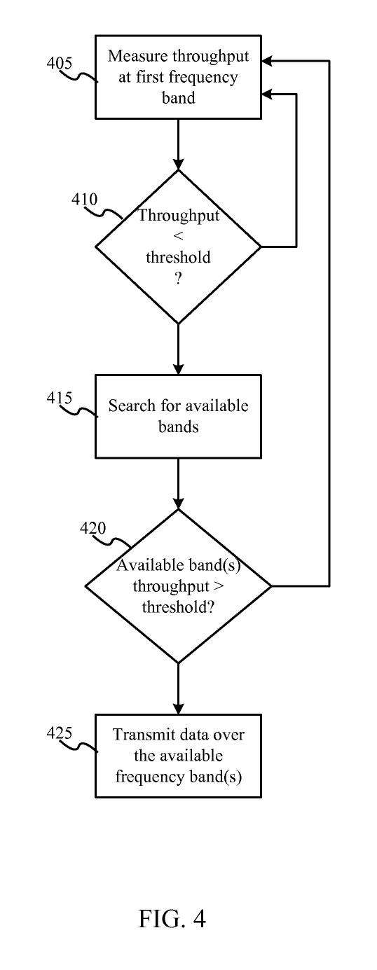

FIG. 4 shows a flowchart depicting a method for finding a frequency band in the event the throughput of the current band decreases according to another embodiment of the invention. At block 405 the throughput of the current frequency band is measured. If the throughput is less than a threshold amount as determined at block 410, then the method moves to block 415; otherwise the method returns to block 405. At block 415 the wireless device searches for available wireless networks. These wireless networks may operate in different or the same frequency bands and/or may be detected by different or the same antennas at the wireless device. The wireless device then determines if any of the available band or bands can provide throughput greater than the threshold or at least greater than the throughput of the first frequency band at block 420. If not, then the method returns to block 405. If frequency bands are available with frequency bands greater than the threshold, then the data transmitted over the first frequency band is changed to transmit over the available frequency bands at block 425.

Multiple Network Throughput

According to another embodiment of the invention, multiple antennas may be utilized to handle high data throughput. For example, if a first wireless network does not provide the bandwidth required by the wireless device, then the data may be transmitted over more than one wireless network. The data may be transmitted in packets. Packets may be allocated to wireless networks based on the throughput of each wireless network. The packets may be transmitted sequentially or in random order. The order of packet transmission may depend on the type of packets being transmitted.

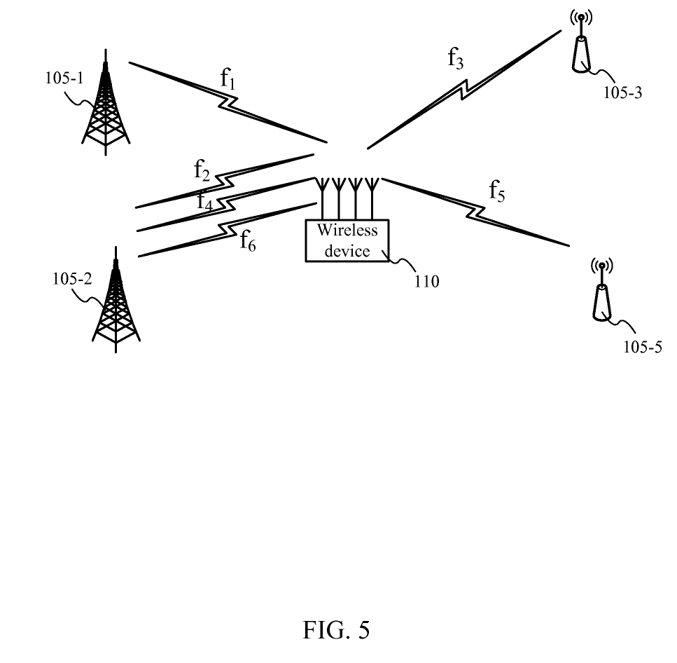

FIG. 5 shows an exemplary wireless device 110 within the communication range of four wireless terminals 105, three of which are operating within a different frequency band 105-1, 105-3, 105-5 and a fourth wireless terminal 105-2 communicating with three frequency bands according to one embodiment of the invention. According to embodiments of the invention, the wireless device may communicate with one wireless terminal 105-2 over more than one frequency band. In another embodiment, the wireless device 110 may communicate with more than one wireless terminal 110 at the same time in order to achieve higher data throughput.

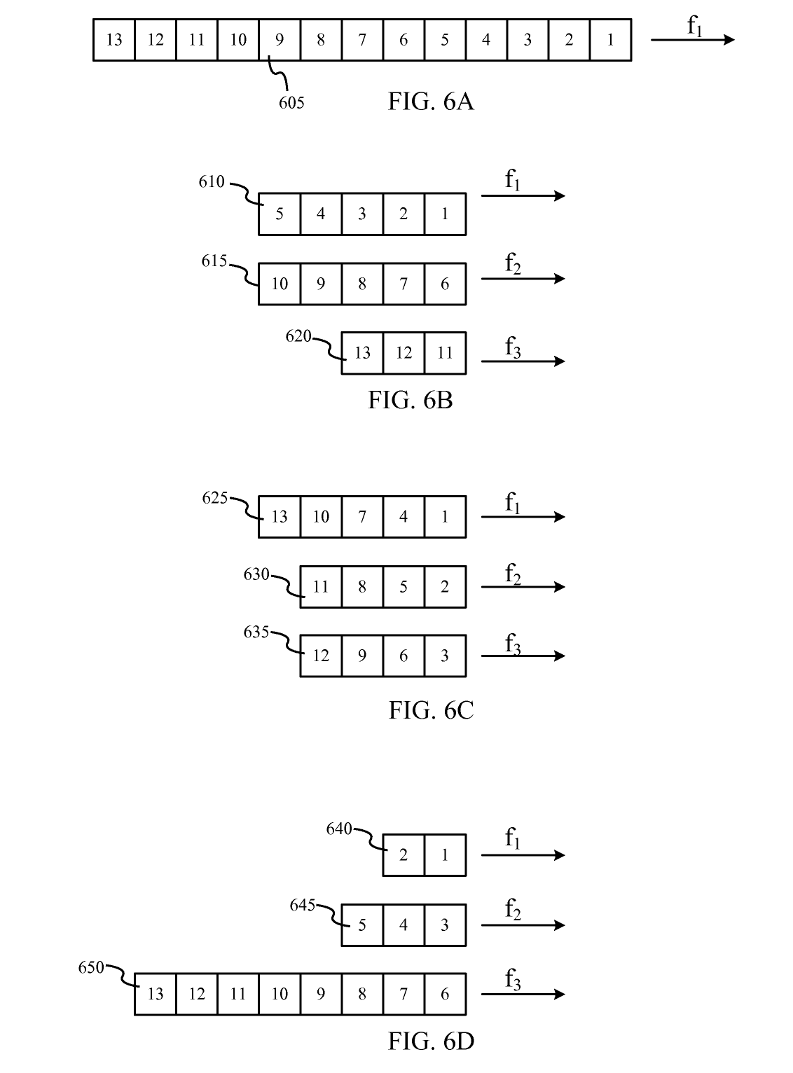

FIGS. 6A, 6B, 6C and 6D show different ways a series of data packets may be broken up and transmitted over different frequency bands according to one embodiment of the invention. Referring first to FIG. 6A, a stream of 13 packets is shown as a single data stream 605 that may be transmitted between a wireless device and a wireless terminal over a single frequency band f₁.

FIG. 6B shows the same 13 packets shown in FIG. 6A broken up and transmitted in three data streams 610, 615, 620 over three frequency bands f₁, f₂, f₃. The data packets are broken up into blocks. That is, the first five data packets are sent over the first frequency band, the second five packets are sent over the second frequency band, and the remaining three packets are transmitted over the third frequency band.

FIG. 6C shows the same 13 packets shown in FIG. 6A broken up and transmitted in three data streams 625, 630, 635 over three frequency bands f₁, f₂, f₃. The data packets are again broken into blocks, but in this embodiment, the data packets are transmitted sequentially through the three frequency bands.

FIG. 6D shows the same 13 packets shown in FIG. 6A broken up and transmitted in three data streams 640, 645, 650 over three frequency bands f₁, f₂, f₃ according to the relative bandwidth of the frequency bands. For example, frequency band 1, f₁, has approximately 2/13s of total bandwidth, frequency band 2, f₂, has approximately 3/13s of total bandwidth and frequency band 3, f₃, has approximately 8/13s of total bandwidth. Accordingly, the packet allocation depends on the bandwidth available on each frequency band.

While the examples shown in FIGS. 6A, 6B, 6C and 6D deal with packets, the data may be broken up by symbol, word, byte, bit, or any other method for consolidating data. Various other schemes for breaking up the data may be employed without departing from embodiments of the invention.

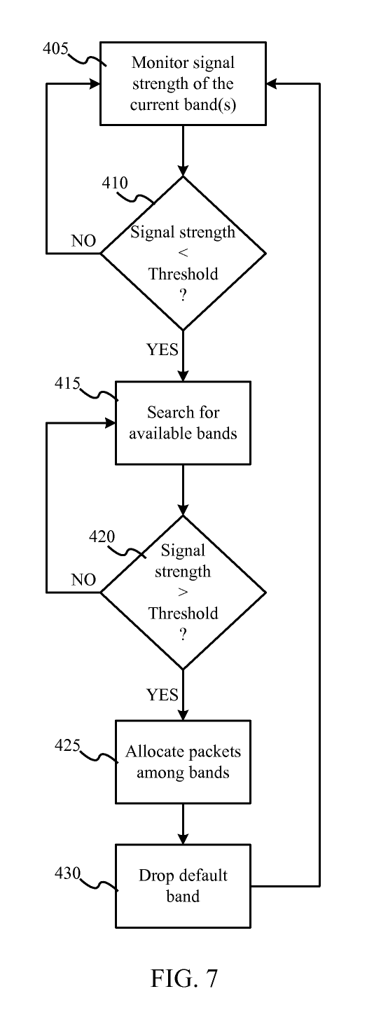

FIG. 7 shows a flowchart depicting a method for adding and dropping bandwidths depending on the signal strength of bands according to one embodiment of the invention. At block 405 the signal strength of a default frequency band(s) is monitored. At block 410, the signal strength of the frequency band is compared with a threshold value. If the signal strength is greater than the threshold, the method returns to block 405. Otherwise if the signal strength is less than the threshold, the method moves to block 415 and searches for available bands and determines if any of the available bands are greater than the threshold at block 420. If not, then the system searches for more frequency bands at block 415. If the signal strength of any of the available bands is greater than the threshold, the method allocates data among the frequency bands with a signal strength greater than the threshold at block 425. The default band is then dropped at block 430. The method may continue at block 405 with the new frequency bands as the default band. This method may combine with other methods to limit the number of frequency bands used to allocate the data based on application-specific parameters. Moreover, the signal strength of the available frequency bands may be compared with the signal strength of the default band rather than the threshold value. If the signal strength of the available bands is greater than the signal strength of the default band, then the method allocates data among the frequency bands with a signal strength greater than the threshold at block 425.

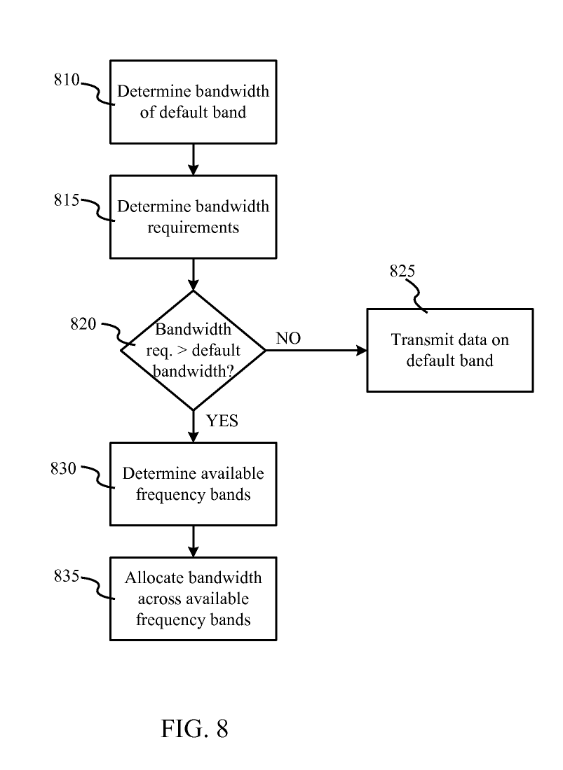

FIG. 8 shows a flowchart depicting a method for allocating data across available frequency bands when the default bandwidth falls below requirements according to one embodiment of the invention. The usable bandwidth of the default frequency band is determined at block 810. This may occur using a look-up table to determine the specified bandwidth of the band or by measuring the available bandwidth of the band. The bandwidth requirements of the application running on the wireless device may then be determined at block 815. These may be determined based on a specific software application, type of use, type of wireless device, etc. The bandwidth requirements are compared with the bandwidth of the default band at block 820. If the bandwidth requirements are less than available bandwidth, data is transmitted on the default band as shown in block 825. If the band width requirements are greater than the default bandwidth, then the method searches for other available frequency bands at block 830. The data is then allocated across these frequency bands and/or the default band at block 835.

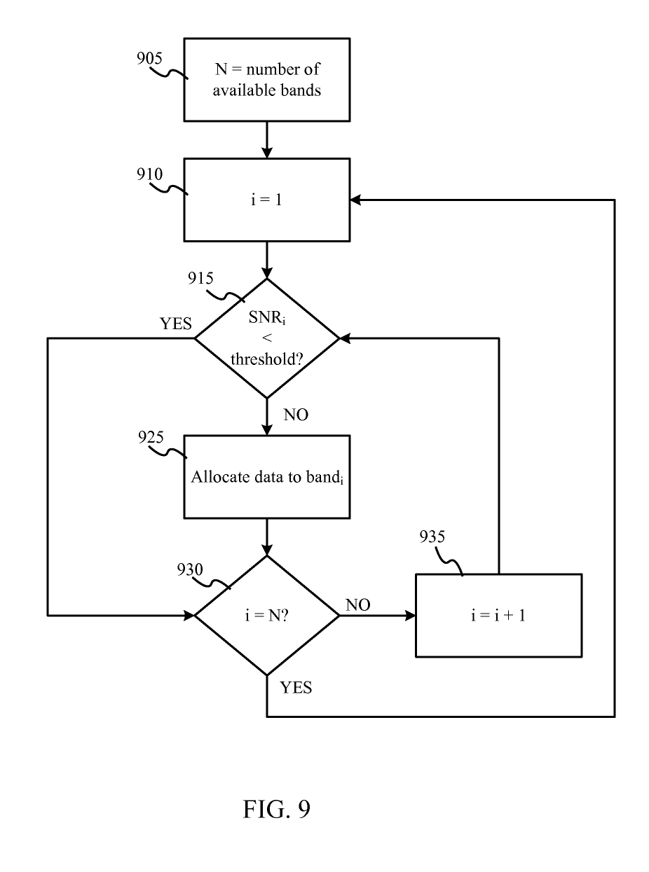

FIG. 9 shows a flowchart depicting a method for allocating data across frequency bands based on the signal-to-noise ratio (SNR) of the available frequency bands according to one embodiment of the invention. At block 905 the variable N is set to the total number of available bands and i is set to equal 1 at block 910. The number of available bands may be determined by monitoring each antenna of the wireless device. The SNR of each band is compared with a threshold value at block 915. While the SNR of a band is used, the method may also compare latency, throughput, speed, bandwidth, etc. If the SNR of a band is less than the threshold, i is incremented at block 935 and the method returns to compare the next frequency band. If the SNR of a band is greater than the threshold, data may be allocated to that band as shown at block 925. The method then checks to see if it has reached the end of the available bands at block 930. If so, then the method returns to block 910. Otherwise, i is incremented at block 935. The data may be allocated in real time to the available frequency bands in real time or the information may be stored in memory until requested or needed.

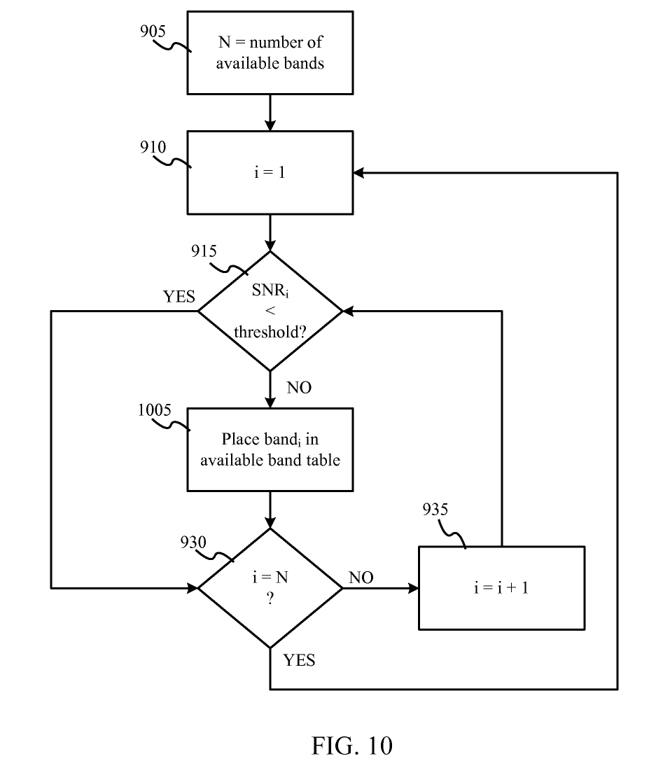

FIG. 10 shows a flowchart depicting a method for allocating data on bandwidths that have a signal strength greater than a threshold bandwidth according to one embodiment of the invention. The flowchart shown in FIG. 10 is similar to the flowchart shown in FIG. 9. However, in this embodiment of the invention, if the SNR is greater than the threshold value, the information about the band is placed in memory, such as a look-up table. The available bandwidth and latency may also be monitored and stored in conjunction with the frequency band. Accordingly, applications that require access to other frequency bands may access the memory and retrieve available bands. Moreover, the application may retrieve a band based on criteria, such as speed, bandwidth, latency, security etc.

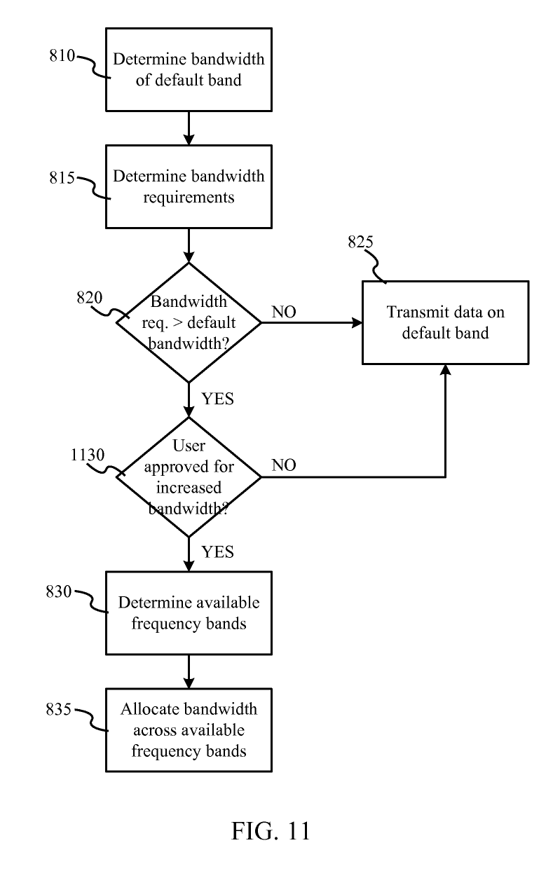

FIG. 11 shows a flowchart depicting a method for determining whether a user and/or device should allocate data across available frequency bands according to one embodiment of the invention. The flowchart shown in FIG. 10 has similar blocks as the flowchart shown in FIG. 8. In this flowchart, however, the method also determines whether the user is approved for an increase in bandwidth at block 1130. Some wireless networks charge a premium for increased bandwidth. Accordingly, at block 820, the method determines whether an increase in bandwidth is needed and then in block 1130 the method considers whether the user is approved for an increase in bandwidth. This increase may occur on the default bandwidth or any other available bandwidth.

Switching Based On Security

According to another embodiment of the invention switching between antennas may be based on security needs. Some wireless networks and protocols are inherently more secure. For example, WiFi networks may include a wired equivalent polociy (WEP) and/or WiFi Protected Access (WPA) encryption Accordingly, a user or a wireless device may select a wireless network based on their security requirements. For example, a user may be surfing the web on a wireless device on a first wireless network. The first wireless network has little security. The user then wishes to manage their finances and they point their browser to a financial webpage and proceeds to login to their secure account. At this point the wireless device recognizes the need for security. The wireless device monitors the available wireless networks, chooses a more secure network, and connects to the more secure network. The wireless device then communicates with the financial institution webpage through the more secure wireless network. This embodiment of the invention may reject higher bandwidth, throughput, cost, etc. in favor of increased security.

As another example, email, applications and/or files with security features enabled may be atomically transmitted over a secure wireless network rather than an non secure network. Some security features may include emails from corporate email domains, internal emails, applications with security features enabled, HTTPS webpages, VPN tunnels, etc. Moreover, various levels of security may also be used. Individual users may require security for all email traffic because of government or trade secret concerns. Moreover, individuals such as financial service providers, doctors, lawyers, accounts may require heightened security. For example, the 4.9 GHz frequency band is designated for secure purposes and may be used to provide secure wireless network access.

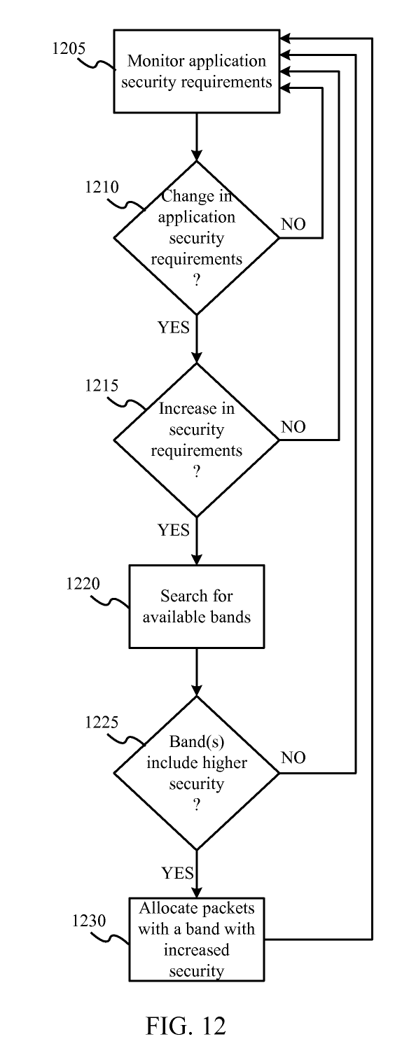

FIG. 12 shows a flowchart depicting a method for monitoring changes in the security requirements and allocating the data across bandwidths that meet the security requirements according to one embodiment of the invention. Security requirements are monitored at block 1205. Block 1210 determines whether there were any changes in the security requirements. If there are no changes, the method returns to block 1205. The method then determines whether the security requirements increased at block 1215. If the security requirements did not increase, the method may return to block 1205. Otherwise, the method may search for available bands at block 1220 and then determine if the available bands provide increased security at block 1225. If a band is found with increased security protocols, then the data may be transmitted using this band with increased security at block 1230. In some cases, if the method detects a decrease in security requirements, then the system may search for and allocate packets to a band with lower security requirements according to another embodiment of the invention.

Switching Based On Network Access Costs

According to another embodiment of the invention switching between antennas may be based on network access costs. Some network access requires payment to access the network or even to access high quality of service on the network. Wireless service providers may charge a premium for such services. Often wireless access may be accomplished over low cost or free networks if they are available. Accordingly, the wireless device may monitor the available networks compatible with the antennas associated with the wireless device and connect to a wireless network(s) based on the fees required for access.

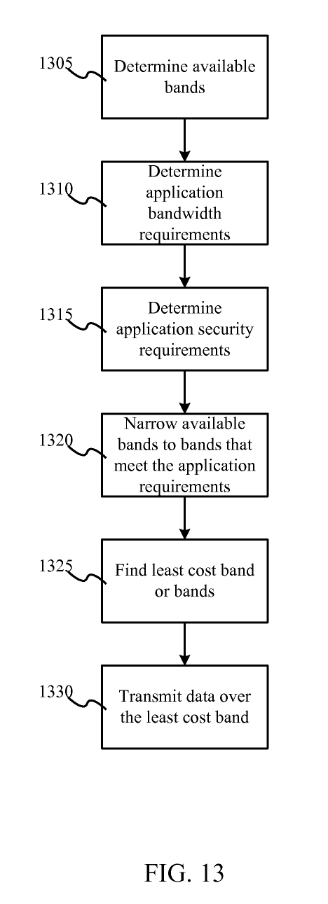

FIG. 13 shows a flowchart depicting a method for determining whether bandwidths meet application-specific needs according to one embodiment of the invention. The method determines the available bands at block 1305. At blocks 1305 and 1310 the method determines the application's bandwidth and security requirements. At block 1320 the available bands are narrowed to include only those bands that meet the bandwidth and security requirements. At block 1325, the method then determines the lowest cost band from the remaining bands. The method then transmits data over the lowest cost band at block 1330. The user may also be involved, through a user interface, and asked whether they wish to use a lower cost wireless network.

According to another embodiment of the invention the wireless device may determine the available wireless networks and then ask a user to determine which wireless network they prefer. The user may be presented with the cost, security and bandwidth of the networks prior to making a choice. For example, the wireless device may detect three wireless networks. The first wireless network has a high bandwidth and high cost to access. The second wireless network has a lower cost and lower bandwidth and the third wireless network is free but has a much lower bandwidth. Accordingly, the user may choose the lowest bandwidth network over the higher bandwidth networks based on cost or may choose any of the three networks based on the users discretion.

Wireless Devices

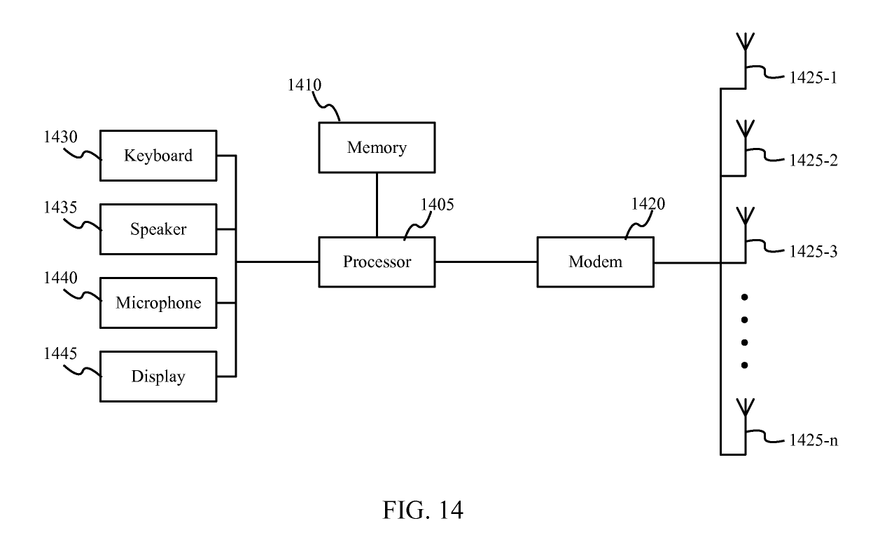

FIG. 14 shows a block diagram of a multiple antenna wireless device according to one embodiment of the invention. The wireless device may include a processor 1405 and memory 1410. The memory may contain various computer programs, routines, algorithms, and/or functions that, when executed by the processor, execute various embodiments of the invention. The processor is coupled with a user interface that may include a keyboard 1430, speaker 1435, microphone 1440 and a display 1445. The processor may also be coupled with a modem 1420 that is used to modulate and demodulate signals received from any of a plurality of antennas 1425. In other embodiments, each antenna 1425 is coupled with a modem 1420. The processor 1405 may execute routines that use one or more antennas 1425 to communicate with one or more wireless terminals to gain access to a network or networks.

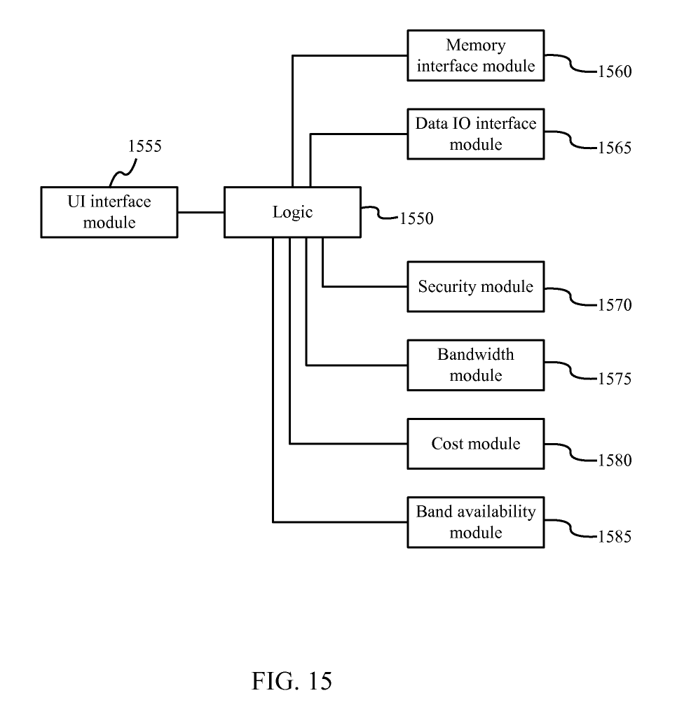

FIG. 15 shows a block diagram showing software modules that implements various embodiments of the present invention. The various software modules may be coupled with a main system logic 1550. The user interface module 1555 provides software functionality for controlling and receiving data from the user interface or interfaces, such as those shown in FIG. 14. The memory interface module 1560 operates to read and write data to the memory. The data input/output interface module 1565 operates to send and receive data to and from the modem. The data input/output interface module 1565 may provide signal processing, filtering, modulating, demodulating, coding, decoding, logic, etc as required.

The security module 1570 may be used to determine the security requirements of the wireless device. The security module may also determine the security level of available bandwidths and whether or not the security of the available bandwidths is sufficient to provide the required level of security. The bandwidth module 1575 may operate to detect the bandwidth of the current wireless network or networks as well as detect the bandwidth of the available wireless networks. The bandwidth module may monitor the bandwidth requirements of the wireless device. The bandwidth module may also operate to determine the bandwidth available over a plurality of bands and how best to allocate data over these bands. The cost module may operate to determine the cost of various frequency bands at block 1580. The band availability module 1585 may detect the availability of wireless networks.

While some portions of the disclosure discuss switching networks by switching antennas, the wireless device may switch networks without switching antennas. For example, a user may access the Internet using a first WiFi network that requires a fee to access. The user may be using the first network and searching for other networks. The wireless device may detect a second WiFi network that does not require an access fee. Accordingly, the wireless device may access the second WiFi network without switching antennas.

The wireless device may also switch between coding, multiplexing and/or modulation schemes as it communicates with a wireless terminal using various wireless networks. These coding, multiplexing and/or modulation schemes may be provided by the protocols associated with the frequency band.

Wireless terminal devices that communicate with wireless devices may also include multiple antennas according to one embodiment of the invention. Accordingly, a single wireless terminal may be coupled with one or more physical network connection such as with a DSL connection, cable connection, Ethernet connection, etc. The wireless terminal may communicate with one or more wireless devices using one or more antennas. As such, the wireless terminals may communicate using one or more wireless networks.

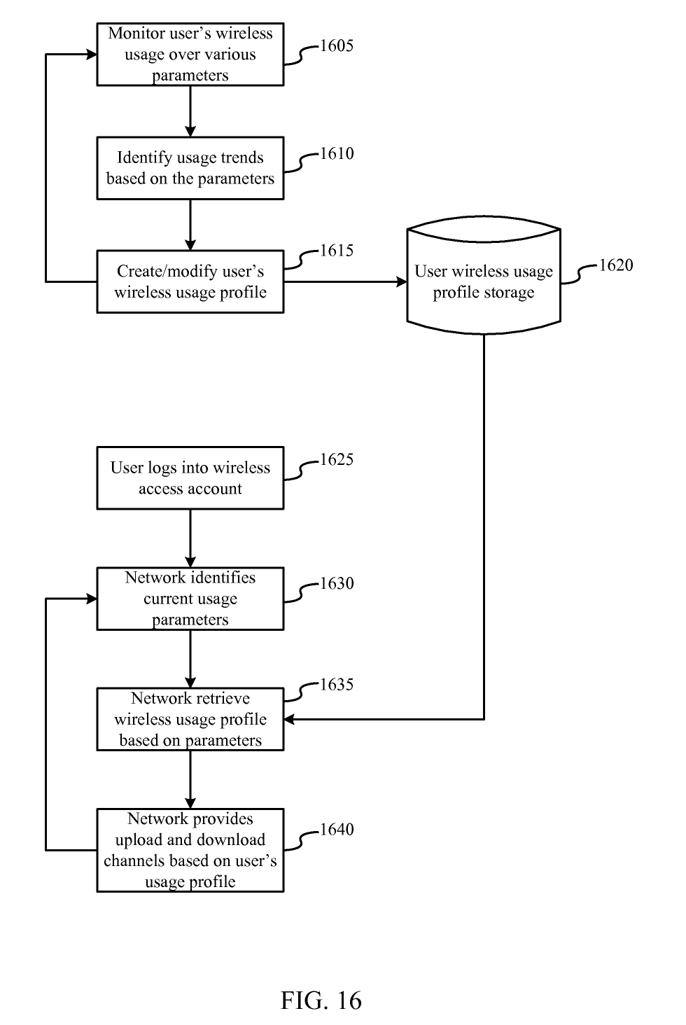

FIG. 16 shows a flowchart of a method for determining user usage profiles and applying user usage profiles in choosing wireless networks according to one embodiment of the invention. The user device or one or more networks monitor a user's wireless usage over various parameters at block 1605. These parameters may include time of day, day of week, location of the user, security, account level, etc. Trends are identified at block 1610 and a profile is created based on the user's usage and the parameters at block 1615. If a user's profile already exits it may be modified as the user's usage changes. The profile is then stored in a storage location on the device or at the network at block 1620.

For example, a profile may include: a work hour profile with the user typically uploads large data file during work hours, after hours profile when the user typically only checks email and possibly checks sport scores on the web; teenager after school profile where the user typically instant messages with friends; teenager in school profile where the device typically lies dormant; on the road profile where the user may access the network from any of various locations and require specific bandwidth needs while traveling, commuting profile where the user typically only uses the telephone while commuting, weekend profile with intermittent network requirements, etc.

When a user logs into their wireless access account at block 1625, the network identifies the current parameters such as time of day, day of week, location, account type, etc. at block 1630. The usage profile associated with these parameters may be retrieved from storage at block 1635. The network may then allocate bandwidth, available wireless channels, and/or quality of service based on the usage profile at block 1640.

For example, a businessman may have established a work day profile between the hours of 9:00 AM and 5:00 PM where the business man sends between 200-300 emails a day many with large data uploads. The businessman logs into a wireless account during working hours his profile is loaded. Accordingly, the network provides two channels a WiFi secure channel for email and a WiMax channel for the large data uploads. Accordingly, the WiFi channel is automatically used for normal email communication (small data sizes) and the WiMax channel is used in the event a large data file is sent via email.

As another example, a teenager has established a profile that shows that 99.9% of the wireless network traffic from the teenager in after school hours are instant messages to a select group of people. When the teenager logs into a public library and registers with the network, the network allocates a single WiFi connection over a free unsecure connection maintained by the library. Another network may be held in backup, such as an EDGE network.

As yet another example, an attorney is working on a vacation at a park during typical business hours. Her profile requires secure access, uses email with medium file sizes throughout the day, and she has paid for premium service. When the attorney logs into her wireless account, the network locates her profile and provides a secure EVDO network channel as a primary email channel and a WiMax backup for medium to large data transfers. Both channels have dedicated higher quality of service but may be lower quality of service than a high bandwidth user. Another user in the same vicinity may also access the network with either or both the EVDO or the WiMas channels. This second user has a poor payment history or may not have a premium account. As such, as the second user access the network and conflicts with the attorney, the second user's access is prioritized below the attorneys providing the attorney with a higher quality of services over the second user.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for allocating wireless communication over one or more frequency bands of the unlicensed frequency spectrum, the method comprising:
detecting the signal strength of each of the frequency bands;
determining whether the signal strength of each of the frequency bands is greater than a threshold value;
allocating data packets to the frequency bands with a signal strength greater than a threshold value, wherein the data packets are assigned in proportion to the available bandwidth at each frequency band; and
transmitting data packets within the allocated frequency bands.

2. The method according to claim 1, wherein one or more of the frequency bands comprise portions of the unlicensed frequency spectrum.

3. The method according to claim 1, wherein the frequency bands are selected from the group consisting of frequency bands centered around about 1.9 GHz, 2.1 GHz, 3.5 GHz, 5.8 GHz, 915 MHz, 1.7 GHz, 1.8 GHz, 1.9 GHz, 2.0 GHz, 2.1 GHz, 2.3 GHz, 2.4 GHz, 2.5 GHz, 2.7 GHz, 3.5 GHz, 3.5 GHz, 3.7 GHz, 450 MHz, 5.25 GHz, 5.3 GHz, 5.4 GHz, 5.6 GHz, 5.7 GHz, 5.8 GHz, 625 KHz, 700 MHz, 8.75 MHz, 850 MHz, 850 MHz, 868 MHz, 868.3 MHz, 900 MHz and 915 MHz.

4. A method for wireless communication between a wireless device and communication wireless terminals, wherein the wireless device includes a plurality of antennas configured to transmit data within a plurality of frequency bands, the method comprising:
transmitting data over a first wireless communication signal using a first frequency band to a recipient through a first communication wireless terminal;
monitoring the signal strength of the first signal;
determining whether the signal strength of the first signal is below a threshold value;
determining the availability of frequency bands other than the first frequency band; and
transmitting data over an available frequency band other than the first frequency band when the signal strength of the first signal is below the threshold value.

5. The method according to claim 4, wherein the wireless device is a mobile phone and the data comprises voice data.

6. The method according to claim 4, further comprising measuring the bandwidths of the available frequency bands other than the first frequency band.

7. The method according to claim 4, wherein the frequency bands, including the first frequency band, are selected from the group consisting of frequency bands centered around about 1.9 GHz, 2.1 GHz, 3.5 GHz, 5.8 GHz, 915 MHz, 1.7 GHz, 1.8 GHz, 1.9 GHz, 2.0 GHz, 2.1 GHz, 2.3 GHz, 2.4 GHz, 2.5 GHz, 2.7 GHz, 3.5 GHz, 3.5 GHz, 3.7 GHz, 450 MHz, 5.25 GHz, 5.3 GHz, 5.4 GHz, 5.6 GHz, 5.7 GHz, 5.8 GHz, 625 KHz, 700 MHz, 8.75 MHz, 850 MHz, 850 MHz, 868 MHz, 868.3 MHz, 900 MHz and 915 MHz.

8. A wireless device comprising:
a plurality of antennas, wherein each antenna is configured to communicate with one or more wireless terminals using a different frequency band; and
a controller coupled with the plurality of antennas configured to determine the available bandwidth of each frequency band and configured to allocate the transmission of data packets over each of the frequency bands with available bandwidth.

9. The wireless device according to claim 8, wherein at least one frequency band comprises a portion of the unlicensed frequency spectrum.

10. A method for communicating wirelessly between a wireless device and a wireless terminal, the method comprising:
communicating data between the wireless device and the wireless terminal using a first frequency band, wherein the data comprises a first data type;
detecting a change in the data from a first data type to a second data type; and
communicating data between the wireless device and the wireless terminal using a second frequency band, wherein the second frequency band provides network efficiencies.

11. The method according to claim 10, wherein communicating the data with the second data type between the wireless device and the wireless terminal using the second frequency band is at least as efficient as communicating data in the second type using the first frequency band.

12. The method according to claim 10, wherein at least one of the first data type and the second data type are selected from the group consisting of voice-over IP; TCP/IP, UDP, multimedia data, instant messaging, text messaging, internet protocol packet, voice-over instant messaging, SCTP, and SPX.

13. A method for wireless communication between a wireless device and communication wireless terminals, wherein the wireless device includes a plurality of antennas configured to transmit data using a plurality of wireless networks, the method comprising:
transmitting data with a first wireless network;
detecting a change in an application-specific network characteristic at the wireless device;
transmitting data with a second wireless network, wherein the second wireless network provides network characteristics that satisfy the application-specific network characteristic.

14. The method according to claim 13, wherein the application-specific network characteristic is selected from the group consisting of bandwidth, latency, security, and cost.

15. The method according to claim 13, wherein each of the wireless networks includes a frequency band within which data is communicated.

16. The method according to claim 13, further comprising transmitting data with a third wireless network, wherein the third wireless network provides network characteristics that satisfy the application-specific network characteristic in conjunction with the second wireless network.
